(19) United States
(12) Patent Application Publication
(10) Pub. No.: US 2009/0280218 A1
(43) Pub. Date: Nov. 12, 2009

(54) PROCEDURE TO OBTAIN WHOLEGRAIN FOOD FOR RUMIANTS

(76) Inventor: Fernando Ruben Ceferino BARRA, De Santa Fe. (AR)

Correspondence Address: DEFILLO & ASSOCIATES, INC., P.O. Box 14104, Clearwater, FL, 33766, US

(21) Appl. No.: 12/175,056

(22) Filed: Jul. 17, 2008

(30) Foreign Application Priority Data
May 7, 2008 (AR) P 20080101945

(51) Int. Cl. A23K 1/22; A23K 1/17

(52) U.S. Cl. 426/69

(57) ABSTRACT

It comprises a 2nd step of selected cereals grinding and a 3rd step of mixing of the grinded cereal with minerals, pellets and fiber for between 3 and 7 minutes until obtaining an homogenous mass. The process also includes a 4th step where a fat component is added, and a 6th step where a protein source is added. It also comprises an 8th step of drying of the obtained wholegrain pieces with hot air and a 9th step of adding a liquid cover which adds a non proteic nitrogen source and amino acids. The final steps of the procedure consist of a 10th step of adding a solid cover which includes antibiotics and minerals and an 11th step of cooling with cold air blowing of the wholegrain food pieces in order to obtain a final product with a temperature which cannot exceede room temperature in more than 5° C. and a residual humidity which cannot exceede the 11%.

### FIELD OF THE INVENTION

This invention consists of a Procedure to obtain wholegrain food for ruminants.

In order to make this invention understandable so that it can be easily put into practice, we will include in the following paragraphs an accurate description of a preferred manufacturing method, making reference to the illustrative Figures attached hereto. Everything constitutes an exclusively illustrative and not limitative example of the invention, the components of which may be selected among various equivalents without getting away from the invention principles set forth in this documentation.

### BACKGROUND OF THE INVENTION

In the previous arte, we may find various procedures developed in order to obtain balanced food for ruminants. Among them, we may mention patent U.S. Pat. No. 6,156,333 related to a “Strengthening and stimulating food for preruminants and using method”, the formulation of which includes between 50 and 75% of proteins; between 10 and 50% of animal plasma; between 2.5 and 10% of micronutrients selected among a high number of mineral elements, such as Co, Cu, I, etc; and organic elements, such as niacin, d-pantothenic acid, riboflavin, etc.

It also has vitamins and no less than 2.5% of electrolytes selected from the salt group Na, Mg, K, Ca and its combinations.

Formulation includes no less than 2% of alicin; 2% of fructooligosaccharides and approximately 1% of microbes selected from the group formed by coagulans, licheniformis, subulis, bifidobacterium bifidum, lactobacillus: acidofilus, casei, milk products, streptococcus diacetylactis and its mixtures.

The quoted document is an extension of patent U.S. Pat. No. 5,795,990 which includes the previous formula and its manufacturing method, which consists in adding a water proportion in order to achieve the dissolution.

Patent U.S. Pat. No. 5,372,811 refers to a food supplement for animals which contains a “co-spray” of dried protein plasma and amylase.

On the other hand, U.S. Pat. No. 4,919,935 consists in a food supplement which adds a bacillus subtilis carrier C-3102, organism placed in the Fermentation Research Institute of the Agency of Industrial Science and Technology of Japan.

From the simple enunciation of the quoted patents, it evidently arises that their compositions do not interfere with the subject matter of this invention and; furthermore, they define a complex and expensive formulation.

There is also extrudated balanced food in our country for domestic animals.

Such is the case of Argentine patent 244.954 which refers to “Balanced food for animals” and constitutes a great protein, vitamin and mineral contribution of great digestibility. Its formulation includes hydrolyzed feathers, fish silage and a vegetal content formed by wheat middling and flours coming from different vegetables.

On the other hand, patent AR N° 240.863 consists of a “Food mineral mixture for ruminants” used for ruminants in the grazing stage. This document reivindicates a formulation which includes macro and micro elements, and it is oriented to obtaining the livestock productive efficacy with the highest yield as regards forage consumed by the animal to achieve a higher weight gain with less forage consumption. The food is composed of ground mineral constituents added in certain proportions.

Almost all formulations found in the previous art are aimed at the feeding animals at home or in agronomic places, and try to improve weight gaining.

We noted that formulations for preruminants are aimed at adding organic or mineral chemical elements, or milk substitutes, in order to accelerate the animal development.

However, they do not consider the natural evolution of the organs involved in digestion and assimilation of nutrients, frequently originating injuries which damage the animal, increasing morbidity and causing premature death in several cases.

### SUMMARY OF THE INVENTION

By definition, wholegrain food for animals is one that includes all physical-chemical characteristics of the diet required by these animals.

We know from the performed researches that bovines do not have a direct control over microorganisms' metabolism of their digestive apparatus, and that there exist important physiological factors that affect gastrointestinal fermentation processes.

This has determined that in order to guarantee that the ruminant has an adequate fermentation patter, that the conditions which promote growing and favorable metabolic patters for the majority of beneficial bacteria and other microorganisms are maintained, food must fulfill the following requests:
Give substrate for the fermentation.
Keep the temperature near 37° C.
Ruminant liquid Osmolarity (ionic charge) must be within an excellent interval, near 300 mosm.
Keep a negative potential of oxidation-reduction, range between −250 and −450 mV.
Delete indigestible rubbish (solid material).
Microorganisms delete rhythm must be compatible with the most favorable regeneration times.
Soften o delete acid products from anaerobic fermentation (volatile fatty acids).

Substrate contribution is a consequence of the act of eating; other factors, such as temperature and ionic charge are fulfilled by means of the homeostatic mechanisms that keep these physiological conditions in the organism; and the appropriate redox potential (oxidation-reduction) only requires oxygen withdrawal from fermentation places.

Remaining requisites need the development of special physiological functions associated with the pre-stomach. Among them, we find ruminoreticular characteristic mobility patters, direct absorption of volatile fatty acids and production of great quantities of saliva.

Fermentation in the rumen is characterized by the selective retention of actively fermentable material, while it allows the non fermentable rubbish to pass to the abomasum.

For that purpose, ruminoreticular walls are muscular, have a wide intrinsic nervous system and are capable of developing and coordinating very complex motility patters, such as the ruminoreticular motility patter, called primary or of mix contractions, and secondary or of eructation contractions.

In general, ruminoreticular contractions take place at a rhythm of 1-3 per minute, and are more frequent while eating to completely disappear during deep sleep stage. Their rhythm and intensity depend on the kind of diet where fibrous food stimulates a greater frequency and intensity.

Secondary contractions can be associated with half of principal contractions, although this relation may vary according to the gas formation rhythm (carbon dioxide and methane above all).

Ruminal intake is stratified and separated by the effects of gravity and ruminoreticular motility. Bovines that receive diets with high levels of forage show different zones or phases of ruminal content. Thus, at the top of the rumen, there is a gas layer (or zone) caused by the accumulation of gasses coming from fermentation.

Under this zone, there is a solid zone composed of intertwined fermented forage particles which keeps floating due to the push created by the air trapped in food particles, as well as due to the little fermentation gasses bubbles which form around the bacteria adhered to the vegetal material.

At the bottom of the rumen, there is a liquid zone with a consistency similar to that of the water, separated from the top solid zone by a pasty zone of vague limits.

These four main zones are created by gravity, and there are two more functional zones created by motility patterns, which are the expulsion zone and the potential escape zone, which constitute the dorsal and ventral areas (superior and inferior) respectively of the reticule and the cranial sacculus.

As it consumes forage, the initial mastication only partially cuts up the particles that come to the reticule as a masticated, tangled bolus formed by big forage parts. The bolus has a functional specific gravity lower than 1 due to the fact that there is air trapped in its interior and between food particles; and it is due to its low specific gravity that the bolus float in the expulsion zone until a contraction takes place in the reticule. After this contraction and due to the pressure it has produced, the bolus comes out from the reticule to the solid zone of the dorsal sacculus.

In this sacculus, bacteria adhere to the forage particles initiating the fermentation during which little gasses bubbles form that help keeping particles specific gravity low. The dorsal sacculus motility mixes the intake and, while it is mixed and the fermentation takes place, particles start fragmentating due to plants structural carbohydrates destruction.

As it becomes smaller, the air trapped escapes and the gasses formation rhythm lowers, thus increasing functional specific gravity.

As this takes place, particles tend to sink and separate in the pasty zone where fermentation and size reduction go on.

In the ventral sacculus (inferior), motility patterns direct the intake flow towards the rumen craneal pillar, even when the material which still keeps a low functional specific density tends to remain suspended on the pasty zone and on the ventral sacculus circulating mass.

Material that reached certain density tends to fall into the other craneal pillar inside the craneal sacculus, in the potential escape zone where this sacculus contractions may move it towards the reticule, from where it can leave the rumen through the reticulo-omasal orifice.

It is possible to see the particle separation system efficiency in the rumen taking into account their sizes in different points of the digestive process. Thus, big portions of forage become smaller with the initial mastication and take the form of particles of 1-2 cm or less in the dorsal rumen (superior). They become smaller in the more ventral portions to achieve a size of between 2 and 3 mm in the particles that go through the reticulo-omasal orifice.

Food particles size in the rumen is a consequence of the microbial action and remastication, while fiber fragmentation speed is a consequence of its digestibility.

Low digestibility fiber takes a longer time than high digestibility fiber to fragmentate enough to reach the potential escape zone. This suggests that it spends more time in the rumen.

As it has a limited volume, food intake; thus, low digestibility food intake is always smaller than that of very digestible diets.

Taking that concept into account, it is stated that diet preparation may affect this relation every time low digestibility grinding or forage cuttings increase their passing speed through the rumen.

Consequently, cutting or grinding often increase the quantity of material the animal can ingest due to the fact that rumen capacity increases, even when its digestibility often decreases as a consequence of increasing its passing speed through the rumen and the subsequent decrease of microbial action exposition time.

For that reason, physical form (length) and digestibility separately affect passing speed through the rumen and food intake.

Rumination may collaborate in the particle separation process due to the fact that when the regurgitated bollus reaches the mouth, it is squeezed by the tongue and the cheeks before starting mastication. This action eliminates water and small particles from the remaining bollus actually making a particle separation process between small and large particles. In this process, when small particles are swallowed again, they tend to sink in the potential escape zone, while big particles return to the pasty zone.

Rumination takes place during the moments the animal is not actively eating, normally when resting but not during deep sleep. Time spent in rumination depends on the kind of diet and varies from almost nothing in the case of high grain level diets up to a maximum of 10 hours a day in the case of high forage level diets.

Water flow has important effects over rumen dynamic. For the small particles and soluble material to leave the rumen, the liquid in the liquid zone of the ventral (inferior) sacculus, the craneal (at the front) sacculus and the reticule must be constantly moving through the reticulo-omasal orifice. This means that there must exist a constant water flow through the solid material mass. In fact, the reticulorumen works as a huge filter, supporting the fermentative mass with particle content, while the water flows through it and drags small particles and soluble material outside. Almost all the water that enters the rumen does it through the esophagus, coming from the salival flow, the water drank or juicy diets.

Water intake speed is affected by food and salt intake speed, or the electrolytes included in the diet.

Small amounts of water enter the rumen through the pre-stomachs epithelium. Besides, as the epithelium is glandular, there is no direct fluids secretion. Normal rumen osmolarity is of approximately 280 mosm/kg, compared to that of the blood and the extracellular liquid that is of 300 mosm/kg. For that reason, the normal osmotic flow goes out of the rumen.

Small particles, including the microorganisms, leave the rumen during the liquid phase. As a consequence, high dilution speeds cause a fast elimination of microorganisms, reducing microbial cell concentrations. In the same way that high microorganism concentrations suppress its division, high water passing speeds (fast delusion) stimulate microbial growth. From the nutritional point of view, high growth rhythms are desirable because a great part of the available energy for microorganisms is used for the growth process instead of the maintenance process, as it happens in relatively stable older microbial populations. In this way, high delusion speeds tend to increase microbial yield values provided there is availability of the appropriate protein to maintain the cellular growth.

Apart from the effect it has over microbial yield, dilution speed may affect the microbial set of the rumen biomass and, in some way, the fermentation pattern.

As microbial discharge speed increases together with dilution speed, when the latter is high, low growth speed microorganisms reduce their population size due to the fact that their replication speed is not high enough to balance discharge speed. In this way, selective pressure favors high growth rhythm species during the periods in which there is a high dilution speed in the rumen.

Although there are exceptions, in general, changes taking place in the rumen with high dilution speeds seem to favor the acetic acid production and the increase in the proportion between the latter and the propionic acid. This is a very desirable effect in the ruminant nutrition field.

In the vagal dorsal nucleus of the brainstem, there is a motility control centre to regulate ruminoreticular motility. This centre sends action potentials throughout afferent fibers towards the pre-stomach by means of the vagus nerve. The reticulorumen presents an extensive intrinsic nervous system; however, vagal innervation is necessary to coordinate normal motility patterns.

Vagal dorsal nucleus receives stimuli that affect the pre-stomach motility control. These signals come from the ruminoreticular light and control distension, intake consistency, pH, volatile fatty acids concentration and ionic charge. Ruminal volume control, or its distension, is made by means of distension receivers present in the rumen walls, mostly in the pillars. A moderate distension growth increases rumen and rumination motility, which, in turn, increases particle fragmentation speed, causing a passing speed increase.

Therefore, rumen capacity increases when a big intake expands the ruminal volume.

Intake consistency also has an important effect over rumen motility. For instance, when they eat finely cut materials, there is little material in the solid zone; and the pasty zone presents a fluid consistency. This kind of intake offers little resistance to rumen pillars movement; that is why, its muscles must exercise relatively little force for the mixture and circulation of rumen contents. Tension receivers of the ruminoreticular muscle seem to control the force necessary to move the pillars between the intake. Very liquid intakes in the rumen are associated with low muscular tension and suggest a negative influence for the ruminoreticular motility.

In the rumen and reticule walls, there exist chemoreceivers that control pH, volatile fatty acids concentration and ionic charge (or osmolarity), causing regulation mechanisms similar to those described for distension. All converge to guarantee a perfect ruminoreticular balance.

The aim of this documentation was that the physical properties of the proposed wholegrain food, i.e., its density, flotation time, form and raw material stratification maximize nutrition equations, omitting the large fiber frequently present in ruminant diets but simulating its role in the rumination act.

As a consequence, contributed fiber is dissociated in order to provide a food physical formation that enables the animals to act as if they were ingesting it in excess.

Said dissociation allows an energetic density increase, adding supplements to cover needs of proteins, minerals, vitamins, etc.

In this way it is possible to modulate the rumen so that it works more efficiently, without suffering injuries or disorders. This can be verified by measuring conversion efficiency, i.e., food quantity in kg ingested based on kg of meat or liter of milk produced.

As a result of greater digestibility of the advocated food, the animal digestive system works more efficiently, causing a clear droppings reduction.

In comparison with conventional food, approximately less than half of solid and gasses that contaminate the environment are produced.

In order to obtain the result revealed in this documentation, density, flotation time and size are adjusted.

As regards food density, it allows us to change its consumption. In fact, the inventor knows that in the rumen pillar, there exist nervous terminals with receivers that test its physical filling.

As this is low density food, it floats inside the rumen making said receivers register filling with a charge lower than the quantity known until now, making them go to the feeder more times per day.

This intake partialization due to lower density causes that the rumen, being charged more times per day, works in a more stable and efficient way.

The second parameter to be considered is flotation time, not only because it defines intake frequency but also because it regulates bacterial growth rate.

In fact, the inventor has determined that the use of the energy delivered by the food changes if it is at the bottom of the rumen or floating above it. This happens because bacterial attack is bigger in the solid and pasty zones, so that due to the fact that it has a higher flotation rate than conventional food, the proposed food fermentation rate increases allowing a better exploitation of the food.

The third parameter to be considered is the wholegrain food size due to the fact that the ruminal bacteria fermentation rate decreases together with the attack surface. For this reason, the revealed wholegrain food is composed of cylindrical bodies of a specific size that the rumen recognizes as fibrous food, and places it in its solid zone. Smaller size receives a bigger bacterial attack due to an increase in the exposed surface, and less time as effective fiber in the rumen.

As a consequence, it arises the concept of simulating fiber by means of finely ground particles that, when they are expanded and conformed in convenient size cylinders, stay in the solid zone of the rumen guaranteeing its movements and, therefore, animals health.

The fact of increasing digestibility by means of the expansion and simulating the effect of fiber in conformation also allows a decrease in the food volume processed, moved and ingested; a decrease in the impact over the environment caused by methane gas and droppings accumulation that constitute the adequate focus to raise insects.

As with any change, an adaptation stage is necessary; this is the time elapsed for an animal to adequate the ruminal flora it carries from the countryside to that which will allow it to ingest the proposed wholegrain food and maximize conversion, i.e., less food per each meat kilo or milk liter obtained.

One of the most important advantages of the wholegrain food of this invention has to do with the fact that, during this transition stage, it is not necessary to provide pastures, i.e., the ruminal flora change takes place regardless of what the animal has been eating in the countryside, by means of manipulation of physical parameters of the wholegrain food.

In this way, the animals will be chemically consuming a fattening diet and, thus, selecting the adequate ruminal flora and fauna, but with the physical parameters of the superior fiber intake, i.e., we place food with fattening chemical characteristics, with physical characteristics of fibrous food, so that the rumen has a slow kinetics and, in turn, selects the best microorganisms for the fattening stage.

This guarantees that the animal behaves as an animal that consumes food with high levels of fiber, as it would happen if it ate in the countryside.

This dissociation of the physical parameters of food that contain a high percentage of fiber is what allows the delivery of a low density wholegrain food, high flotation time (obtained due to the inclusion of more soya husk, cotton, sunflower, etc. in the formula) and a low attack surface, with a formula chemically similar to that of a fattening diet, minimizing the recommended adaptation time for the transformation of cellulolitic in amiolitic flora.

After the adaptation stage, it comes the fattening stage, where the energetic exploitation is maximized due to the fact that the food is always the same, so that it can stabilize the digestive system every time the rumen can be considered a true fermentation barrel.

Due to the fact that it is an homogeneus food as regards its phisicochemical properties, the rumen will always work with the same components, in the same proportions and with the same dynamic.

Conversions extremely under those described in texts are achieved in this stage.

An issue that highly affects animals with the traditional food is the management of food during rainy days. In such cases, wholegrain food allows us to vary the physical parameters without chemically changing the fattening formulation and, therefore, the flora, in order to avoid acidosis episodes, i.e., it will be possible to change the size maintainig the formulation, and enlarge it so that there be a a decrease in the bacterial attack as a result of a reduction of the exposed surface.

Another possibility is to increase the wholegrain food flotability in order to make it last longer in the solid and pasty zone due to the fact that it keeps floating during a longer time; and due to the action of the terminals mentioned before, the animal lowers the food intake.

The inventor has also studied the result obtained in the dairy farms with animals assigned to milk production.

In this case, taking into account the lack of grass, food must be adapted adjusting it by cow categories, differentiating those of first farrowing from those of multiple farrowing.

In turn, one of the two cow categories must be separated in: fresh cows (those with 28 days of birth) and not pregnant high production cows, pregnant cows and lower production cows.

In all categories, there is a tenency to maximize individual production based on grouping animals with similar requirements and with the same competence conditions.

This is very complicate in the exploitation of animals over grazing production, but is becomes much more simple if we assign animals to different pens and provide them with the corresponding food.

We usually refer as dry cows to those animals that are within the period of 60 days prior to delivery, and as transition cows to those that are within the period of 21 days prior to delivery.

We refer as heifers to those females that have never delivered; as livestock breeding to the cows until the delivery time and as rearing livestock to those that are 60 days old and until the age of delivery capacity.

Eliminating the grass, food administration becomes easier as this component represents the biggest volume in the animal's diet and it also presents different inconvenients which increase in the production intensive systems. Among those inconvenients, we point out the bigger occupied storage place, which requieres big investments in order to harvest and conserve it, labor force and time to include it in the livestock nutrition.

If we compare the proposed wholegrain food with the classic TMR, also known as mixer or total mixed rations, we note that the most important advantage of the invention is that this new concept deals with density, flotation time, and bacterial attack surface, modifying the nutrition equations known until the present, allowing to decrease grass quantity to zero if we replace it with other fiber source and affecting the bacterial attack surface.

Unlike TMR, wholegrain food allows to build complete, automatized food plants with specialized labor force.

In this way, costs and mistakes are minimized, and production controls and distribution are simplified, starting to build the equivalent of poultry production systems.

The revealed wholegrain food has a great advantage due to the fact that it disregards grass and, thus, avoids raw material variability control since grass is a natural food and it is subject to variations due to conditions beyond the production, such as the climate and the time of the year, among others.

Consequently, meat and milk production becomes independent from those conditions since they are replaced by controllable physical fenomena with simple techniques.

From the comparison between the proposed wholegrain food and common pelletized balanced food, it is observed that the present invention is an expanded food, i.e., it is subject to a process by means of which cellular lysis takes place in order to leave starch mollecules exposed to bacteria.

Since the finished product is somewhat spongy, it presents an increase in the bacterial attack surface against pellet surface, accelerating the attack and the exploitation on the part of the bacteria.

The wholegrain food is extrudated, what guarantees an increase in digestibility and, consequently, a higher production performance and a sudden reduction in the environment pollution.

Another very important difference to point out is that pelletized process started to be used in order to increase product density and, thus, lower the freight costs; however, it does not gelatinize starch or favor digestion. It only increases consumption in some cases and decreases breathing problems due to a smaller dust quantity.

The proposed wholegrain food is thought to work with low density, even when the appropriate density will depend in each case on the production system and the animal category, i.e., the required energy. A higher production will be associated with a higher density.

In the previous art, both the expander and the extrusor used in animal nutrition use screws that compress a mass of celerals and pellets and, at the same time, add water and water steam so that they produce changes in the carbohydrates, which geltinize, and in the proteins, which insolubilize, producing changes in the physicochemical patterns, in comparison with raw cereals.

There are also some reactions between the carbohydrates and the proteins which render these complexes insoluble and, therefore, produce an undesirable effect in nutrition.

In order to avoid these undesirable effects, the inventor has made changes in the extrusor that enable its exploitation in the production of wholegrain food for ruminants and its adaptation to the production systems, thus correcting the imbalance caused by the conventional extrusion, where carbohydrates become more fermentable (ruminal digestion) and proteins more insoluble (intestinal digestion).

Thus, in order to obtain the wholegrain food for a ruminant in the extrusor, we will put the grains, the fiber source and part of the proteic source to later add more proteic source in order to balance digestion places and increase density.

In the proposed wholegrain food, the proteic source is composed of pellets, and the fiber source is composed of sunflower husk, soya husk, ground roll of soya weeds, etc.

Stratification of said components must be done based on the bacterial attack, thus, it is necessary to design the expander so that the wholegrain food remains stratified so that bacteries start finding from the outside to the inside a higher proportion of fiber, cargohydrates and proteins, in order to make the rumen work in the most effecient way possible.

The inventor has also modified another concept as regards the ruminant food, which is that of covers.

As regards the compounds added to the previous art food, the inventor could establish the existence of two inconvenients.

The first inconvenient detected is that some of the probiotics, antibiotics and/or vitamins added did not pass the expander stage since they were submitted to a temperature and pressure which deteriorated them rendering them inefficient. For that reason, the solution consists in adding them after passing that stage.

The second inconvenient comes from determining that some minerals favor certain bacterial flora growth at the expense of others, so the solution encountered consists in selecting a specific substrate based on the ruminal flora we want to have. This also allows us to establish an addition order to form a stratified capable of allowing some bacterial colonies to develop before others.

The concept frequently used in the nutrition of ruminants in the previous art consists in using a mineral vitamin nucleus obtained after one or several premixtures later incorporated to the mass.

The concept of this invention is based on using the mineral nucleus, just as seen it in the previous art but adding liquid and solid cover layers to modulate the growth of different bacteria colonies.

The liquid cover adds a non proteic nitrogen source which is necessary to neutralize the fast ruminal fermentation of a product that is so fermentable as pregelatinized starches. Besides, said non proteic nitrogen is capable of generatin proteins from the bacterial fermentation.

The liquid cover also adds amino acids, yeasts and bacteria. The inclusion of each one of them depends on the necessary balance for each animal category.

The solid cover includes the antibiotics and minerals necessary to select bacterial colonies based on the mineral substrate they need to grow and reproduce.

The location of each product, minerals, antibiotics, probiotics, yeasts, amino acids and non proteic nitrogen in the solid or liquid cover will always depend on the product presentation in the market and on its stability in a watery medium.

The fact that wholegrain food is independent from fiber allows to produce meat or milk in places where producing fiber is expensive, thus reducing costs, especially in regions where it has to be transported or produced with irrigation systems.

The fact that the concepts of density, flotation time and size connect with that of the fiber known up to the present allows to formulate diets with between 4 and 15% of roughage. The latter can consist in sunflower husks, soya husks, soya rolls or other little digestible fiber sources, such as the sugar cane or the sawdust, becoming independent from grass.

The wholegrain food allows to have a product which is bacteriologically stable and which gives the possibility of controlling all known variables.

It also allows to have a plant where it is possible to mix and expand, if necessary, different diet components and, at the same time, it allows to define and vary density, flotation time and food size, so that all animals consume the same food all day and the food is totally mixed in identical proportions.

It also allows to add nucleus and covers to select the ruminal ecosystem, maximizing food conversion to meat or milk as a result of an improvement in the energy exploitation equation, reducing the medium pollution.

In the previous analysis made up to the moment, the use of the proposed wholegrain food allows to obtain livestock weight increases equal to those obtained in the known feed lot of Argentina with consumptions that range between 20 and 40% less than the consumptions in said feed lot.

One of the advantages of the wholegrain food proposed in this documentation is the reduction of droppings inside the pens of the animals that consume it, consequently decreasing mathane release.

In order to obtain an estimation which allows to establish the reduction of methane releases with the wholegrain food of the present invention, we have consulted the work “Methane production in dairy cows” which appeared in Journal of Dairy Science 62, 1583-1586 (Moe and Tyrrell, 1979), from which we got the following formulation:

Methane in Mj/day=3.41+0.51NFC+1.74HC+2.65C

NFC stands for non-fiber carbohydrates; HC stands for hemicellulose and C for cellulose, all measured in Kg/day.

In the formula, it is easy to understand that working with a lower quantity of fiber reduces the quantities of hemicellulose and cellulose, which are the two heaviest components (they multiply by 1.74 and 2.65) and, thus, the most contaminating ones.

### BRIEF DESCRIPTION OF THE FIGURES

FIG. 1 hereto includes different components that form each of the diets recommended for rainy days. In said Figure, there appear each component quantities, expressed both as weight and percentage; and each price is indicated as well as the final price per food ton.

FIG. 2 attached hereto reveals meat and feces production expressed in tons, using the traditional food and the wholegrain food.

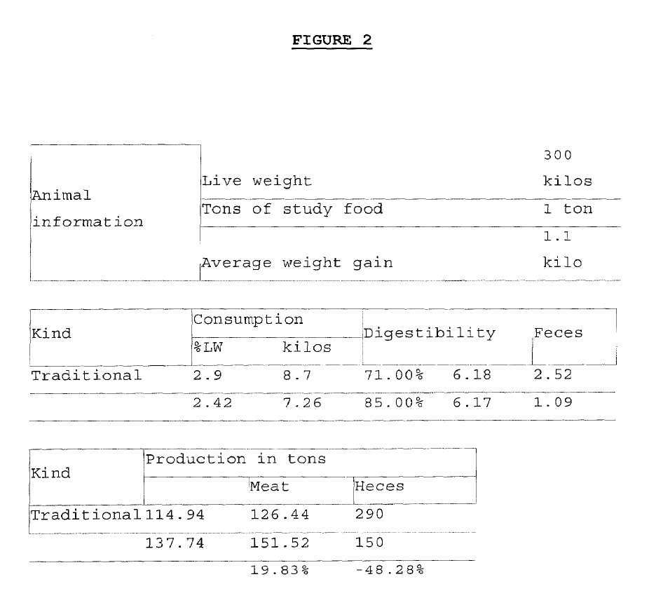

### DESCRIPTION OF THE INVENTION

Basically, this invention consist in wholegrain food for ruminants that avoids the use of pastures and replaces it with fiber sources which are easily controllable.

The food includes minerals, antibiotics, probiotics, amino acids and vitamins, stratified in layers arranged so as to favor the development of certain bacteria colonies or to establish a certain order in the development of a plurality of bacteria colonies.

The proposed wholegrain food includes corn, sorghum, sunflower pellets, delintated cotton, sunflower husk, mineral nucleus, sodium bicarbonate, sodium chloride, liquid cover and solid cover.

The addition of fats to the spread wholegrain food is extremely easy since it is added in the expander preconditioner when the mass is humidified and warmed; and even though they can be of animal or vegetable origin, in our country, SENASA does not approve those of animal origin. This is why, vegetable oils are used despite its extremely higher price.

The wholegrain food also includes minerals, antibiotics, probiotics, non proteic nitrogen, proteins an amino acids.

OPERATION: Once the different components of the invention version developed to explain its nature have been established, the description is complemented by the functional and operative relation of its parts and of the result provided by them.

The aim of this documentation is to reveal a Procedure to obtain wholegrain food for ruminants which allows to eliminate the grass from the diet of these animals and achieve a better energy exploitation with a reduction of feces and, consequently, of methane release. It is determined that its components vary their proportion depending on the fact that the food is to be ingested during the animal adaptation stage or during the fattening stage.

Besides, components can be changed in the case of wholegrain food administration during rainy days, as well as taking into account each of the categories that take part in the dairy farm production, i.e., calves, heifers and dairy cows.

An alternative fiber source is used in order to eliminate the grass from the ruminant diet and, thus, become independent from the plantation, harvest, storage and distribution of a natural product which, as such, is subject to variations that usually escape its quality control.

Everything mentioned here allows to point out among the advantages of the proposed wholegrain food that it has a fast answer speed, making it possible to be adapted to the different requirements.

It must also be highlighted that when becoming independent from the grass, all wholegrain food components can be added in a single manufacturing plant and distributed as any balanced food.

The wholegrain food allows to maintain a common rumen fermentation pattern, avoiding intestinal dysfunctions.

It is highlighted that the addition of protein material after the extrusion allows it to be partially used in the rumen.

Even if the extrusion increases food digestibility, making the starch digestible in the rumen, it modifies the proteins that become more digestible in the intestine.

For this reason, it is common in the USA to gelatinize starch using a corn crusher previously warmed at 100° C. and humidified at 25% of humidity.

Afterwards, it is mixed with corn silo, alfalfa hay or the like as fiber sources; and with sunflower pellets, cotton seed, soya pellets, wheat middling or the like as protein sources.

The inventor knows that, even though starches are pregelatinized, what is highly beneficial for the ruminant nutrition, the passage through the extrusor determines protein alteration making it digestible in the intestine.

Taking into account that according to what the inventor has determined, it is necessary that the protein remains, at least in part, available in the rumen, this invention proceeds to incorporate part of the protein sources after the extrusion stage and prior to the product conformation stage in the screw, i.e., without being extrused.

According to what has been mentioned, the revealed procedure comprises the following stages: determination and weight of formula components; ground of the cereals to be incorporated in the wholegrain food; mixture of said ground cereals with pellets, fiber and minerals to obtain an homogeneous mass; humidification and warming of the obtained mass; entry of the mass into the expander and expandion of the mass; addition of a protein source previously humidified and warmed; formation of the expanded mass with the protein source addition in order to obtain the wholegrain food; drying; addition of the liquid cover and cooling.

In the procedure revealed herein, the 1st step comprises the determination and weight of the selected formula components, for which, as it has already been mentioned, formulation can be modified to be more favorable for animals under the adaptation stage, differentiating it from that for animals under the fattening stage or from the most adequate for dairy cows nutrition.

In the same way, the formulation can be adapted to be used in rainy days.

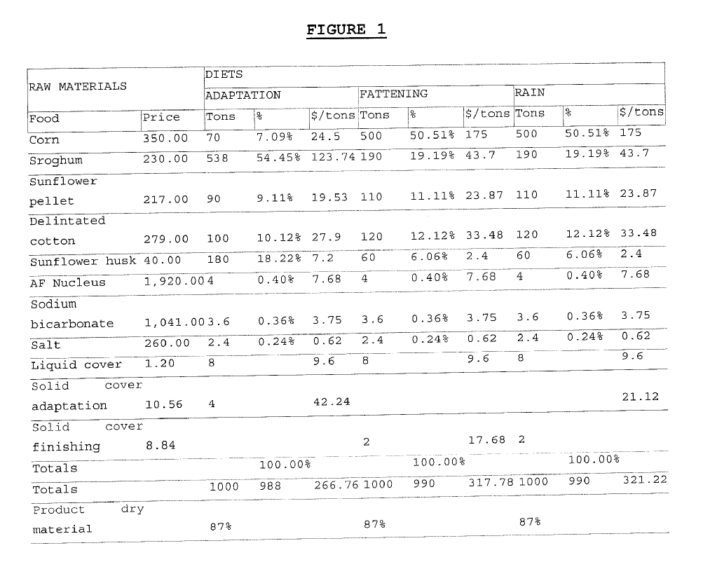

As seen in FIG. 1, the highest variation corresponds to the corn percentage which increments in the fattening stage at the expense of sorghum. Values reverse in the adaptation stage.

We also see that in rainy days, and taking into account that the animal will certainly ingest humid food, it is advisable that the formulation includes some antibiotic in the cover in order to reduce any possible intestinal dysfunction.

In these cases, it would also be appropriate to increase the fiber or its effect, for instance, increasing the size.

Intake frequency can also be reduced increasing flotation time by means of the addition of sunflower husks, soya husks, cotton husks, etc.

In the 2nd step of the procedure, selected cereals are ground according to the desired objective, as we see in the already mentioned FIG. 1. According to the information included in said Figure, cereal is selected among corn, sorghum, cotton seeds, sunflower pellets, sunflower husk, soya pellets, soya husk or their combinations.

In the 3rd step, minerals are added to the milling resulting from the previous step which has been previously put in a mixer, and mixed in order to obtain an homogenous mass. In this step, the mix is done in intervals of between 3 and 7 minutes.

In the 4th step, the homegeneous mass obtained in the previous step is warmed and humidified applying water and water steam and, in its case, fat selected from between a vegetable oil and an animal fat is added.

In the 5th step, mass is put in an expander to expand it.

In the 6th step, a protein source formed by, for instance, pellets previously humidified and warmed by means of water and water steam is added. In this step, the added pellets can be of soya, corn, sorghum, sunflower, cotton, safflower or their combinations.

In the 7th step, the already expanded mass, together with the addition of a protein source in the previous step, is included in a screw in order to fractionate it in wholegrain food pieces that will be later distributed for its consumption. Said screw forms the mass in cylindrical bodies of approximately 13 mm of diameter and 20 mm of length.

However, as we have seen for the diet suggested for rainy days, the length and diameter of the pieces may vary.

In the 8th step, the pieces obtained are dried using warm air. This is done because once the pieces covers are completely dry, in the 9th step, a liquid cover is added, thus incorporating a non protein nigrogen source to neutralize the fast ruminal fermentation of pregelatinized starches and generate proteins from the bacterial fermentation.

Liquid cover of the ninth step also adds amino acids capable of selecting colonies and yeasts.

In the 10th step, a solid cover is added which includes antibiotics, amino acids, probiotics and minerals necessary for the ecologic selection of the bacterial colonies based on the mineral substrate they need to grow and reproduce.

Finally, in the 11th step, the pieces of the wholegrain food obtained are cooled. The cooling is done blowing with cold air, and it aims at lowering the pieces temperature to a range which cannot exceed room temperature in more than 5° C.

After the drying, residual humidity contained in the pieces obtained with the revealed procedure cannot exceed the 11%.

In this way, we have made a summary one of the constructive possibilities that leads to put the invention into practice and the way in which it works. Documentation is complemented with an invention summary contained in the claims that follow.

1. A procedure to obtain wholegrain food for ruminants in which the components of a formula that comprises, at least, one cereal among corn, sorghum, sunflower, cotton seeds, sunflower pellets, sunflower husk, soya pellets, gluten feed, safflower pellet, soya husk or their combinations are determined and weight; antibiotics, probiotics, amino acids and minerals are added, in which the mixture is warmed and humidified adding water and water seam in order to later put it in an expander to expand it; also of the kind in which the mixture is added to a fractioning screw, characterized by the fact that it comprises
a 2nd step of selected cereals grinding;
a 3rd step of mixing of the grinded cereal with minerals, pellets and fiber for between 3 and 7 minutes until obtaining an homogenous mass;
a 4th step of adding a fat component;
a 6th step where there is a protein source addition;
an 8th step of drying of the obtained pieces with hot air;
a 9th step of adding a liquid cover which adds a non proteic nitrogen source and amino acids;
a 10th step of adding a solid cover which includes antibiotics and minerals; and
an 11th step of cooling with cold air blowing of the wholegrain food pieces in order to obtain a final product with a temperature which cannot exceed room temperature in more than 5° C. and a residual humidity which cannot exceed the 11%.

2. The process according to claim 1, wherein in the 6th step the protein source is formed by pellets previously humidified and warmed with water and water steam.

3. The process according to claim 1, wherein in the 6th step the added pellets are chosen from soya, corn, sunflower, cotton and safflower pellets or their combinations.

4. The process according to claim 1, wherein in the 7th step the mass is included in a screw that forms the mass in cylindrical bodies of approximately 13 mm of diameter and 20 mm of length.

5. The process according to claim 1, wherein in the 7th step, the mass is included in a screw that forms the mass in cylindrical bodies of different lengths and diameters.
